(19) United States
(12) Patent Application Publication
(10) Pub. No.: US 2026/0225319 A1
(43) Pub. Date: Aug. 6, 2026

(54) A METHOD AND A DEVICE FOR CALCULATING A TOOLPATH FOR A THREE-DIMENSIONAL MODEL FOR ADDITIVE MANUFACTURING

(71) Applicant: CEAD IP B.V., DELFT (NL)

(72) Inventors: Maarten Jan LOGTENBERG, DELFT (NL); Bart Armand PRUIJMBOOM, DELFT (NL); Jasper KLEIN MENTINK, DELFT (NL)

(21) Appl. No.: 19/154,361

(22) PCT Filed: Jan. 30, 2024
(86) PCT No.: PCT/NL2024/050040

§ 371 Date: Aug. 6, 2025

(30) Foreign Application Priority Data
Feb. 10, 2023 (NL) 2034125

(51) Int. Cl. B29C 64/386; B33Y 50/00

(52) U.S. Cl. CPC B29C 64/386; B33Y 50/00

(57) ABSTRACT

A method for calculating a toolpath for a three-dimensional model for additive manufacturing is disclosed. The method comprises the steps of: slicing the 3D model into a first even number of layers, each layer comprising a plurality of lines and a plurality of nodes having one or more lines connected thereto; calculating the toolpath per second even number of layers such that movement of a print head on each one of the second even number of layers always traces a line without any interruption, by switching to another one of the second even number of layers for a particular node, the particular node being a node on one of the second even number of layers where movement of the print head from the node to another node, on the same layer, without tracing a line is needed, wherein the second even number being smaller or equal to the first even number.

### TECHNICAL FIELD

The present disclosure generally relates to the field of additive manufacturing, more particularly, to a method and a device for calculating a toolpath for a three-dimensional, 3D, model for additive manufacturing.

### BACKGROUND

Additive Manufacturing, AM, otherwise known as solid freeform fabrication or 3D printing, has seen a large amount of growth since its inception a few decades ago.

Advances in additive manufacturing technology make 3D printing a viable fabrication method for a variety of materials beyond thermoplastics, including elastomeric materials such as silicone, glass, epoxies, and concrete. When 3D printing viscous materials, as opposed to traditional thermoplastic filaments, it is difficult to stop and start the flow of material. Most print path or toolpath generation software makes use of the printer's option to enable or disable material flow when constructing the toolpath. These toolpaths tend to produce low-quality prints when used with materials that must be extruded continuously.

Toolpath is the computer-controlled movement of a tool in a manufacturing process. In additive manufacturing, it is the path of the laser beam, extruder head, or cutting tool. A toolpath can be described as an ordered set of n layers, Each layer consists of a sequence of space-filling curves over which material is extruded.

Generating a toolpath for a print head to fill the boundary of an arbitrary model shape in one continuous motion is a nontrivial problem. Conventional slicing algorithms take advantage of the fact that thermoplastic type systems can precisely control filament flow, so the resulting extruder paths need not be continuous as the material flow can pause while the print head moves to another region of the print. With materials that have to be extruded continuously, as fluid extrusion is continuous, these paths that pass over the middle of the print or cut across concave outlines drop excessive material onto the printed object which detracts considerably from print quality.

In consideration of the above, it is desirable that there is a method for designing toolpaths for 3D printing models which can reduce excessive extruded material so that the resulting path is better suited to 3D printing fluids or continuous extrusion.

### SUMMARY

In a first aspect of the present disclosure, there is presented a method for calculating a toolpath for a three-dimensional, 3D, model for additive manufacturing, the method comprising the steps of:
slicing the 3D model into a first even number of layers, each layer comprising a plurality of lines and a plurality of nodes having one or more lines connected thereto;
calculating the toolpath per second even number of layers such that movement of a print head on each one of the second even number of layers always traces a line without any interruption, by switching to another one of the second even number of layers for a particular node, the particular node being a node on one of the second even number of layers where movement of the print head from the node to another node, on the same layer, without tracing a line is needed,

wherein the second even number being smaller or equal to the first even number.

The present disclosure is based on the insight that undesired effect, such as excessive material dripped onto the printed object, generated by moving the print head from a node to another node without tracing a line during printing can be obviated by a method of calculating the toolpath for the print head when an even number of layers are considered at the same time.

For the purpose of implementing the method, the 3D model for additive manufacturing is sliced into an even number of layers, which is referred to as a first even number of layers in the description. Then the toolpath is calculated per second even number of layers, the second even number being mostly smaller than the first even number, the second even number may also be equal to the first even number when the 3D model is a small one.

In calculating the toolpath, starting from a first one of the second even number layers, it is designed such that the print head will move to a second one of the second even number of layers. This happens when the print head comes to a particular node on the first one of the second even number of layers where it is not possible for the print head to move to another node on the first one of the second even number of layers by tracing a line between the two nodes. This prevents the print head from moving from one node to another node on the same layer, without tracing a line. It thereby helps to avoid excess material from dripping to undesired locations.

When moving on the second one of the second even number of layers, the print head will move back to the first one of the second even number of layers when it is necessary, like when the print head comes across a node on the second one of the second even number of layers where it cannot go to another node on the same layer by tracing a line.

It can be contemplated by those skilled in the art that when more than two layers are considered together when calculating the toolpath, the print head has the possibility of moving between the second even number layers. It is not necessary that it always go back to the first one from the second one of the second even number of layers.

In an example of the present disclosure, the particular node on one of the second even number of layers comprises a node having all lines connected thereto on the same layer traced once.

It can be understood that when all lines connected to a node, on the same layer, has been traced once, when the print head comes to such a node, it either has to move to another node without tracing a line, or has to trace a line which is already traced. Either situations are not desirable. Therefore, the print head at this moment moves to a different layer, instead of going on at the same layer.

In an example of the present disclosure, the second even number of layers comprises two layers, the calculating step comprises:
tracing lines on a first layer by repeatedly moving the print head from a current node to a further node by tracing a line connecting the current node and the further node until reaching a particular node on the first layer
determining that there are untraced lines on the first layer;
switching to a second layer by moving the print head in a direction across the two layers to reach a corresponding particular node on the second layer;
tracing one or more lines on the second layer starting from the corresponding particular node until reaching a node on the second layer where tracing a line from a corresponding node on the first layer becomes possible;
switching back to the first layer by moving the print head in a direction across the two layers to reach the corresponding node on the first layer as a current node;
repeating the above steps until all lines on the first layer are traced once.

In designing the toolpath by considering two layers at the same time, the print head can start from a first layer and try to trace as many lines as possible on the first layer. This is done by moving from a current node to a further node on the first line by tracing a line, and then taking the further node as a current node and moving to still another node on the first layer by tracing a line. The procedure repeats until the print head comes to a particular node on the first layer as defined above.

At this particular node, the print head switches to the second layer. For the purpose of improving the efficiency of movement of the print head, the present disclosure proposes that the print head, after switching or moving to the second layer, may come back to the first layer at an earliest possible node. This allows the first layer to be printed first before the second layer.

Based on this consideration, it is determined, after the print head comes across a particular node on the first node and before it switches to the second layer, whether there are still lines remain untraced on the first layer.

In case there are still untraced lines on the first layer, after moving to the second layer, when the print head traces a line on the second layer and moves to a node on the second layer where there are lines to be traced at a corresponding node on the first layer, the print head will move back to the first layer and continue to trace lines on the first layer until it arrives at a further particular node on the first layer.

The above procedure is repeated until all lines on the first layer are traced. This helps to keep the printed product in a more robust structure as a first layer, which normally is a lower layer, is completely printed before the second layer.

In an example of the present disclosure, after all lines on the first layer are traced, the method further comprises the steps of:
switching to the second layer by moving the print head in a direction across the two layers to reach a node on the second layer, when all lines on the first layer are traced once;
tracing lines on the second layer by repeatedly moving the print head from a current node to a further node by tracing a line connecting the current node and the further node until all lines on the second layer are traced once.

Untraced lines on the second layers are now all traced. Due to the fact of considering two layers together, it is ensured that the print head can effectively trace all remaining lines on layer two, without meeting the difficulty of having to move from a node to another one without tracing a layer.

In an example of the present disclosure, the step of tracing lines on the first layer starts with a starting node selected by the steps of:
finding nodes that are closest to each other across all of the first even number of layers;
selecting one of the found nodes on the first layer as the starting node.

In practice the print head can start from any node on the first layer. For the purpose of improving the efficiency of printing, in the present disclosure, it is proposed that the print head starts from one of nodes that are closest to each other across all of the first even number of layers. This helps to reduce the vertical and horizontal movement of the print head across different layers.

In an example of the present disclosure, the steps of tracing comprises:
tracing a line connected to a current node where the print head is and making the smallest angle with an immediately traced line, when four or more lines are connected to the current node.

When tracing lines on a layer, if there is only one line connected to a node where the print head currently is, it will trace that line. However, when the print head arrives at a current node having more than one lines connected thereto, a decision has to be made as to which line the print head should follow.

In the present disclosure, it is designed that when the print head arrives at a current node connecting four or more lines, including the line that the print head just traced to arrive at the current node, the next line to be followed or traced by the print head is a line that makes the smallest angle with the immediately traced or just traced line.

In an example of the present disclosure, the above decision of choosing a line to follow by the print head is valid for both a line belonging to a closed contour connected to the current node and a branch not belonging to a closed contour connected to the current node.

A branch as used herein refers to a line on a layer of the 3D model which does not belong to any closed contour.

In an example of the present disclosure, the tracing steps comprises:
tracing a line connected to a current node where the print head is and making the largest angle with an immediately traced line, when three or fewer lines are connected to the current node.

In contrast to the above described example where a current node connects four or more lines, when the current node connects to three or fewer lines, it is designed that a next line to be traced by the print head is a line that makes the largest angle with an immediately traced line. Here, the line that makes the largest angle with an immediately traced line may also be a line belonging to a closed contour connected to the current node and a branch not belonging to a closed contour connected to the current node.

The above principles used in calculating the toolpath helps to generate a more efficient toolpath.

In an example of the present disclosure, the step of tracing lines on the first layer comprises tracing a branch when both branches and closed contoured are connected to a current node where the print head is.

When calculating the toolpath for the first layer, it is preferred that a branch is traced first, if a node has both one or more branches not belonging to any closed contour and lines forming part of a closed contour connected thereto. This is because following a closed contour first may have the result that there are branches left untraced. By giving priority to the branches, it has the beneficial technical effect of allowing all lines to be traced once.

In an example of the present disclosure, the step of tracing one or more lines on the second layer comprises first tracing a line belonging to an available closed contour(s) connected to the corresponding particular node on the second layer before tracing a branch not belonging to any closed contour.

This is in connection with the principle of trying to trace all lines on the first layer as soon as possible. Thus, it is preferred that lines belonging to closed contours on the second layers are traced first, which will allow the print head to move back to the first layer at an earlier time.

In an example of the present disclosure, tracing a line belonging to an available closed contour(s) connected to the corresponding particular node comprises:
tracing a line of a closed contour among two or more closed contours connected to the corresponding particular node and forming the smallest angle with the immediate traced line.

In an example of the present disclosure, wherein tracing a line belonging to an available closed contour(s) connected to the corresponding particular node comprises:
tracing a line of a single closed contour connected to the corresponding particular node and forming the smallest angle with the immediate traced line, when four or more lines are connected to the corresponding particular node, or
tracing a line of a single closed contour connected to the corresponding particular node and forming the largest angle with the immediate traced line, when three or less lines are connected to the corresponding particular node.

In a further example of the present disclosure, the step of tracing one or more lines on the second layer comprises:
tracing a branch not belonging to a closed contour and connected to the starting point and making the smallest angle with an immediate traced line, when four or more lines are connected to the starting point, or
tracing a branch not belonging to a closed contour and connected to the starting point and making the largest angle with an immediate traced line, when three or less lines are connected to the starting point.

The above design considerations help to optimize the calculation of the toolpath such that the toolpath as a whole does not cross itself at the same height. This effectively prevents the occurrence of ugly or maybe even weak spots.

Specifically, the above described exemplary decision tree between following a line on a closed contour or a branch not belonging to a closed contour when both are an option to traverse at layer 1 helps to improve print quality, though such an decision is not mathematically necessary.

Moreover, decision tree between “equal” lines (both on a branch or on a closed contour at the same layer) according to their angle and the amount of lines connected to the current node is necessary to make sure the toolpath does not cross itself at the same height, which also helps to improve print quality, though such decision seems to be not mathematically necessary.

In the meantime, decision tree between following a line on a closed contour or a branch when there is no line available to be traversed at layer one and both are an option to traverse at layer 2 is mathematically necessary in order to reach the starting point while tracing all lines an equal amount of times. A second aspect of the present disclosure provides a processing device configured to perform the method according to the first aspect of the present disclosure.

A third aspect of the present disclosure provides a computer program product, comprising a computer readable storage medium storing instructions which, when executed on at least one processor, cause said at least one processor to carry out the method according to the first aspect of the present disclosure.

### BRIEF DESCRIPTION OF THE DRAWINGS

FIG. 1 schematically illustrates, in a flow chart type diagram, a method for calculating a toolpath for a 3D model for additive manufacturing.

FIG. 2 schematically illustrates a layer resulted from the slicing step of FIG. 1.

FIGS. 3a to 3e schematically illustrate an example of tracing lines on layer 1.

FIGS. 4a and 4b schematically illustrate an example of tracing lines on layer 2.

FIG. 5 schematically illustrates, in a flow chart type diagram, an exemplary method for calculating a toolpath for a 3D model per two layers.

FIG. 6 schematically illustrates an example of tracing a branch.

FIG. 7 schematically illustrates, in a flow chart type diagram, an exemplary method for calculating the toolpath on the second layer.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

Throughout this description, the term “a/the current node” refers to a node that a print head is currently at, by arriving at the current node from another node by tracing a line connecting the two nodes or starting from a node; the terms “node” and “point” are used interchangeably.

For the purpose of preventing undesirably dropping of continuously extruded material during the process of additive manufacture or 3D printing, the present disclosure proposes a novel method for calculating a toolpath for a 3D model. The method is based on an inventive idea of calculating the toolpath per even number of layers, normally per two layers.

According to the method of the present disclosure, when a print head comes to a node on a current layer of the 3D model, referred hereafter in the present description as a particular node, where movement of the print head from the particular node to another node without tracing a line on the same layer is needed, the print head is moved to a next layer different than the current layer.

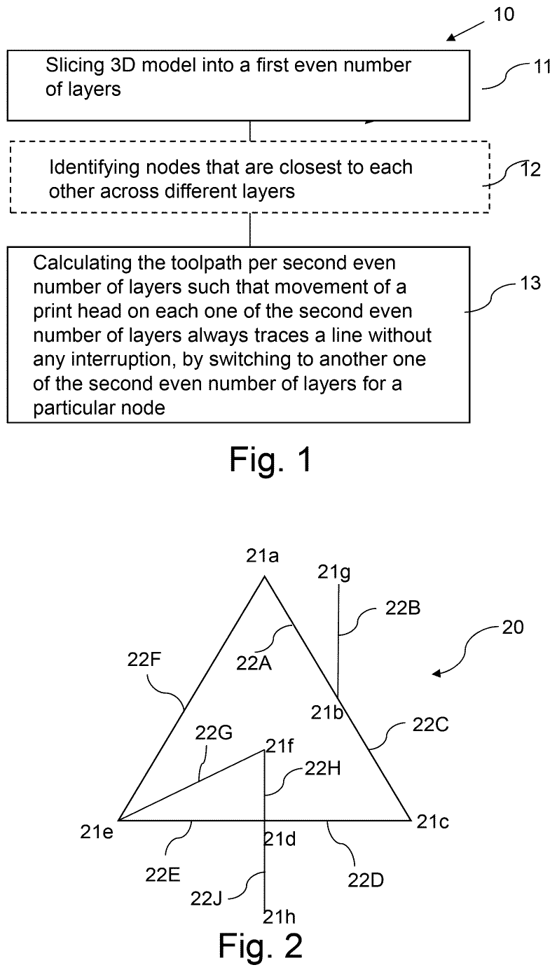

FIG. 1 schematically illustrates, in a flow chart type diagram, a method 10 for calculating a toolpath for a 3D model for additive manufacturing.

The method 10 starts with step 11 where a 3D model for additive manufacturing is cut or sliced into an even number of layers. This is realised by cutting the 3d model with planes representing layers so that lines remain on each layer. As can be contemplated by those skilled in the art, the lines may comprise straight lines or line segments, or curved lines. As a result, each resulting layer comprises a plurality of lines and a plurality of nodes having one or more lines connected thereto.

For the convenience of description, the total number of layers in the 3D model is referred to as a first even number of layers, so as to differentiate from a collection of layers which are considered together when calculating the toolpath for the 3D model.

FIG. 2 schematically illustrates a layer 20 resulted from the slicing step 10. The layer comprises nodes 21a-21h and lines 22A-22J. A point having one or more lines connected to it is defined as a node. As an example, node 21g has a single line 22B connected thereto, while node 21b are connected to three lines 22A, 22B and 22 C, in other word, lines 22A, 22B and 22 C meet at node 21b. Similarly, line 22C and 22D meet at node 21c, and lines 22D, 22E, 22H and 22J meet at node 21d.

Referring back to FIG. 1, at step 12, nodes that are closest to each other across different layers are found or identified.

As an example, in a layer next (not shown) to the layer 20 as illustrated in FIG. 2, there can be nodes with coordinates corresponding to that of the nodes 21a-21f on the layer 20. Specifically, it can be assumed that each plane is represented with coordinate axis x and y, while a direction across different layers is represented with coordinate axis z. Assuming node 21a has coordinates (21a-x, 21a-y, 21a-z), in an adjacent layer, there can be node having coordinates (21a-x, 21a-y, 21a-z′). It can be contemplated that a difference between z-z′ is defined by a distance between two adjacent layers. Such two nodes are considered as being closest to each other.

It will be understood by those skilled in the art that nodes considered as being closest to each other across different layers may differ from each other in terms of each of their x, y and z coordinates.

Such nodes are identified for the purpose of choosing proper nodes as starting nodes for calculating the toolpath.

In practice, if only a set of two layers are considered, each node can be a starting node as across two different layers each pair of nodes with the same or similar x-and y-coordinates lie closely two each other.

However, between multiple layers, nodes that are very close to each other across different layers have to be identified. As will be described in the following, this helps to keep the print head from travelling and oozing in the meantime.

At step 13, the method proceeds to calculated a toolpath per second even number of layers. The calculation is performed in such a way that movement of the print head on each one of the second even number of layers always traces a line without any interruption. This is realised by switching or moving the print head to another one of the second even number of layers for a particular node. The particular node is a node on one of the second even number of layers where movement of the print head from the node to another node, on the same layer, without tracing a line is needed.

As an example, the toolpath may be calculated every two, four, six or eight layers. A person skilled in the art will understand that the second even number of layer is generally smaller than the first even number of layers. When the 3D model is a small one and only comprises a few layers, it is also possible that the second even number of layers is equal to the first even number of layers.

Starting from one of the node identified at step 12 on one of the second even number of layers, the toolpath is calculated by tracing lines continuously from a node to another node and switching to another one of the second even number of layers for a particular node where movement of the print head from the node to another node without tracing a line on the same layer is needed, until all lines on the second even number of layers are traced.

The above summarises the inventive idea of the present disclosure. In the following, detailed steps of calculating the toolpath will be elaborated with reference to an example where the toolpath is calculated by considering two layer at the same time. In other words, the second even number of layers in the following example is equal to two.

Assuming that the method starts with the first two layers of a sliced 3D model. Nodes closest to each other are identified. The method starts from any of the identified node on Layer 1, by considering the node as a starting node. In the case that there is only one line connected to the starting node, this single line is traced to arrive at a further node.

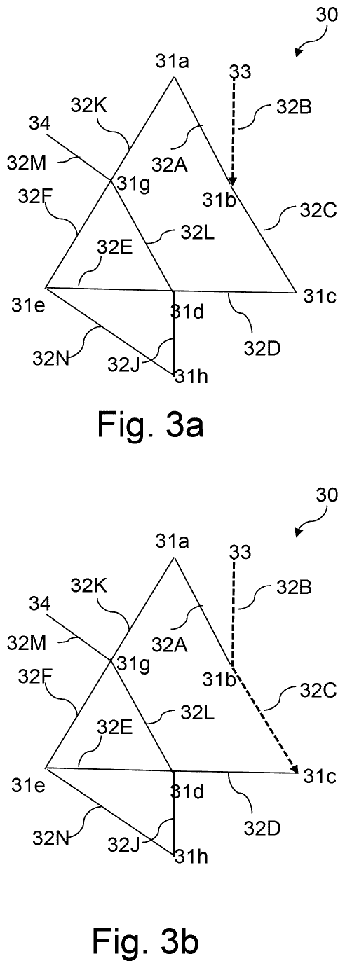

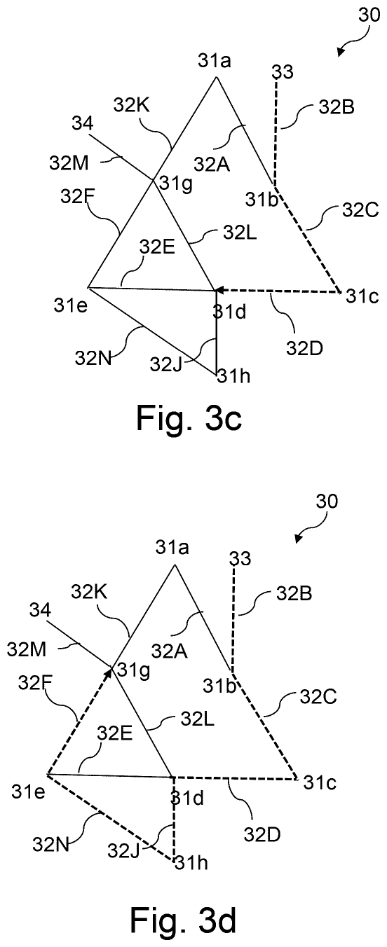

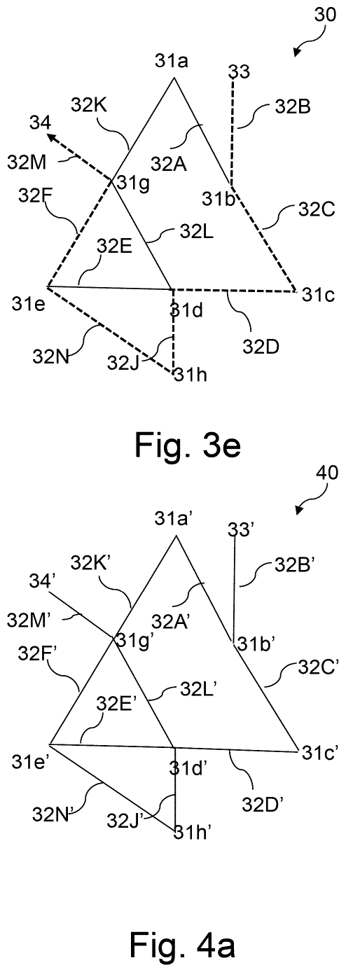

Referring to FIG. 3, in which Layer 1 is illustrated as a layer numbered 30. Assuming that a point 33 is taken as the starting point, the print head traces the only line 32B starting from 33 to arrive at node 31b. An arrow is used in the present description to indicate a current position of the print head, as illustrated in FIG. 3a. A traced line is illustrated as a dotted line.

Node 31b is now taken as a new starting point, or considered as a current node. Three lines 32A, 32B and 32C are connected to node 31b, and lines 32A and 32C are available to be traced. In this case, there are less than four lines connected to the node 31b, a next line to be traced is chosen as the line 32C forming the largest angle with the line 32B that is just traced.

As illustrated in FIG. 3b, line 32C is traced, and now the print head arrives at node 31c. At node 31c only line 32D is available to be traced. Therefore the print head now traces line 32D to arrive at node 31d, which is illustrated in FIG. 3c. Node 31d has four lines connected thereto, that is, 32D, 32E, 32J and 32L. In this case, an available 32E line forming the smallest angle with the immediately traced line 32D is traced, to arrive at the node 31h. From 31h the only available line 32N is traced to arrive at node 31e. Node 31e is connected to three lines 32N, 32E and 32F. Therefore line 32F which forms the largest angle with line 32N is traced, arriving at node 31g. The situation on layer 30 is now as illustrated in FIG. 3d.

It is noted that in considering an angle between two lines, a straight ahead line would be 180 degrees, a right angle to the left would be 90 degrees, but a right angle to the right would also be 90 degrees. So all angles will be between 0 and 180 degrees.

Node 31g is connected to four lines 32F, 32M, 32K and 32L. Line 32M is a line which does not belong to a closed contour. Such a line is referred to as a branch in the present disclosure.

In the scenario as illustrated in FIG. 3d, there is only one branch 32M connected to node 31g. The print head in this case traces line 32M to arrive at a point 34, as illustrated in FIG. 3e.

The calculation of the toolpath for situations involving more branches will be described with reference to another drawing later.

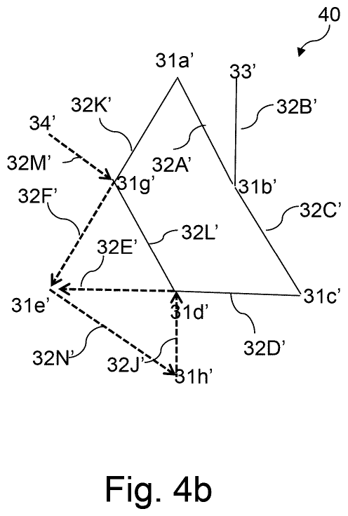

At point 34, the print head cannot move to another node on this same layer by tracing a line. In other words, node 34 is a particular node as used in the present disclosure. Therefore, based on the inventive method of the present disclosure, the print head moves vertically across the layers to Layer 2, from point 34, arriving at a node which is closest to point 34′ on Layer 2. It is assumed that Layer 2 has the same design as Layer 1, as illustrated in FIG. 4a.

At layer 40 (Layer 2), starting from point 34′, following the above procedure as described for Layer 1 with reference to FIGS. 3a to 3e, the print head will trace line 32M′ to arrive at node 31g′, then trace line 32F′ to arrive at node 31e′, trace line 32N′ to arrive at node 31h′, trace line 32J′ to arrive at node 31d′, and trace line 32E′ to arrive at node 31e′ again. The resulting situation on Layer 2 is illustrated in FIG. 4b, in which arrows are used to indicate the movement of the print head.

At node 31e′, all lines connected to this node on layer 40 are traced. Therefore, the print head at this node cannot move to another node on this same layer 40 by tracing a line. Therefore, the print head at this point moves vertically back to Layer 1 which is illustrated as layer 30 in FIGS. 3a to 3e.

Referring back to FIG. 3e, the print head, now at 31e, will trace line 32E to arrive at node 31d, trace line 32L to arrive at node 31g, trace line 32K to arrive at node 31a, and trace line 32A to arrive at node 31b.

When the print head arrives at node 31b of layer 30, all lines on this layer have been traced once by the print head. The print head therefore moves to Layer 2, arriving at node 31b′.

At Layer 2, node 31b′ is connected to a closed contour formed by lines 32A′, 32C′, 32D′, 32L′ and 32K′ and a branch 32B′. In this case, the print head follows the closed contour by tracing each line, and then comes back to node 31b′. The print head then traces line 32B′, to arrive at point 33′.

At this point, all lines on both layers are traced. The print head always traces a line, only once, during its movement along each of Layer 1 and Layer 2. It thereby prevents undesired dripping of printing material resulting from the movement of the print head from a node to another without tracing a line.

A person skilled in the art will understand that the method may be implemented by considering more layers, such as four or six layers, achieving the same technical effect as described above, as long as an even number layers are considered together.

In tracing lines on Layer 2, the above described method allows more freedom as it is not required that the print head moves back to the Layer 1 as soon as possible. In an alternative and preferred embodiment described in the following, when calculating the toolpath by considering two layers at the same time, the print head back moves back to Layer 1 as soon as possible, after the print head has moved to the second layer.

In this preferred embodiment of the present of the present disclosure, for the purpose of ensuring that all lines on a lower layer, as Layer 1 or layer 30 described in the above example, are traced overall at an earlier stage, priority is given to nodes on Layer 1. This is implemented in the calculating method as moving the print head back to Layer 1 as soon as possible, after the print head has moved to the second layer due to encountering a particular node on the first layer.

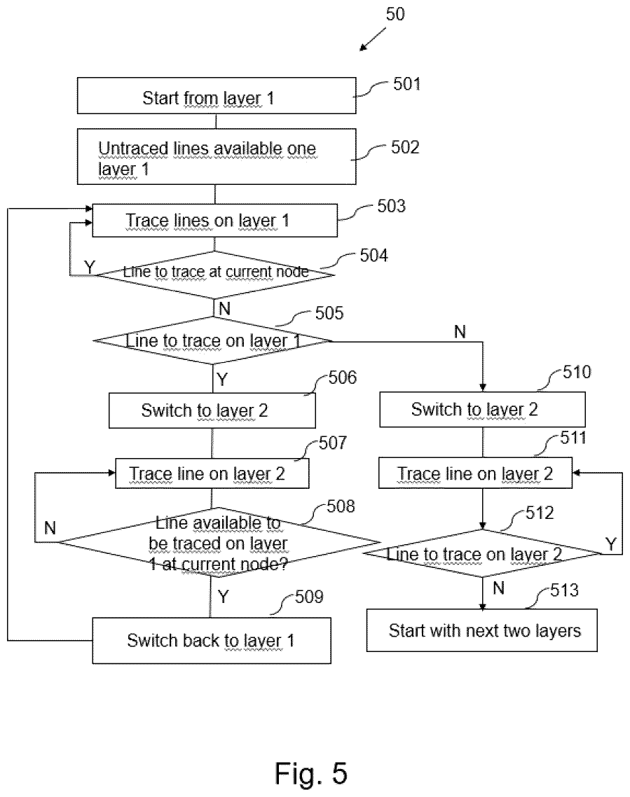

FIG. 5 schematically illustrates, in a flow chart type diagram, an exemplary method 50 for calculating a toolpath for a 3D model per two layers.

The method 50 starts at step 501, in which the print head starts from Layer 1, which can be for example the lowest layer of the sliced 3D model.

As the method just starts, at step 502, it can be decided that there are untraced lines available on layer 1.

Therefore, at step 503, starting from a node selected as a starting node, the print head traces a line on layer 1. The starting node may be selected as discussed above at step 12 with reference to FIG. 1.

By tracing a line from the starting node, the print head arrives at a further node, which is referred to as a current node. At this point, it is determined at step 504 whether there is one or more lines to be traced at the current node.

If it is decided that there are lines available to be traced at the current node, the flow goes back to step 503, allowing the print head to trace another line on layer 1.

It can be contemplated by those skilled in the art that there might be multiple lines connected to the current node. In this case, a line to be traced is determined in the same way as described above with reference to FIG. 3a to 3e.

At step 504, it may be determined that there is no line to be traced at the current node, in other words, all lines connected to the current node are traced once. Then the current node is referred to as a particular node, where the print head cannot move to another by tracing a line. In this case, the print head will move vertically to layer 2.

Depending on whether there are still untraced lines on layer 1, it will determine whether the print head, after moving or switching to layer 2, will come back to layer 1 or not. Therefore, before moving the print head to layer 2, it is determined at step 505 whether there are still one or more line to trace on layer 1.

If it is determined that there are untraced lines on layer 1, at step 506, the print head switches or moves to layer 2. The print head moves vertically across layer 1 and layer 2, connecting the two layers with a very short path. This allows the print head to arrive at a node on layer 2, which corresponds to the particular node on layer 1 and is referred to as a corresponding particular node and taken as a current node.

From the current node, at step 507, the print head traces a line on layer 2, in the same way as described above. The print head thereby arrives at another node on layer 2, which is regarded at a current node.

At step 508, while the print head is still positioned on layer 2, it is checked or determined whether a corresponding node on layer 1 has a connected line to be traced.

If the decision at step 508 has a negative result, the print head goes back to step 507 to go on tracing lines on layer 2. On the contrary, when it is determined at step 508 that there is a line to be traced at a layer 1 node which corresponds to the current node on layer 2, at step 509, the print head switches back to layer 1.

Then the flow starts from step 503 again, to trace lines on layer 1, and to switch the print head to layer 2 when it comes across a particular node. Steps 503 to 509 are repeated until the print head arrives at a node where all lines are traced once, and there are no more lines to be traced on layer 1, that is, when step 505 has a negative decision result.

The flow then moves to step 510, that is, the print head now has to switch to layer 2. Following that, steps 511 and 512 are repeated until all nodes are layer 2 are traced once. The flow then moves to step 513, where the next two layers may be printed following the same procedure as described above.

Following the method 50 as described above with reference to FIG. 5, for the same design as illustrated in FIG. 3, a further toolpath different than that illustrated in FIGS. 3a to 4b may be obtained. Such a toolpath is described briefly in the following.

This further toolpath remains the same until FIG. 3e, where the print head switches to layer 2. At this point, the print head moves up to layer 2, to arrive at node 34′. Here it traverses from node 34′ to node 31g′ over line 32M′, as this is the only available line to traverse at layer 2.

At the corresponding node 31g on layer 1, lines 32K and 32L are not traced and therefore available to be traced. Therefore, the print head switches from layer 2 to layer 1, moving from node 31g′ on layer 2 to node 31g on layer 1 by connecting the two nodes with a short path.

Four lines are crossing at node 31g, therefore the line that makes the smallest angle with line 32M (32M′) is traversed, arriving at node 31a, then from node 31a to 31b over line 32A, which is the only available line at layer 2.

At node 31b on layer 1, all lines 31A, 31B and 31C connecting to this node are traced once. Therefore the print head switches to layer 2 to arrive at node 31b′. Available lines at node 31b′ on the second layer are 32A′, 32B′ and 32C′. Lines 32A′ and 32C′ are part of a closed contour and will only be considered. There are three lines connected to node 31b′, therefore the line 32C′ that makes the largest angle to line 32A is traversed) to arrive at node 31c′, then from node 31c′ to node 31d′ over line 32D′, which is the only available line to be traversed at node 31c′ on the second layer.

On layer 1 node 31d which corresponds to node 31d′ on layer 2 has lines to trace, that are line 32L and 32E. Therefore, the print head moves down to layer 1 to node 31d. Four lines are crossing at node 31d, therefore the line 32L that makes the smallest angle from line 32D (32D′) is traversed, arriving at node 31g.

At node 31g on layer 1, all four lines 32F, 32M, 32K and 32L are traced once. Therefore the print head moves up to node 31g′. Available lines at node 31g′ on the second layer are 32K′, 32L′ and 32F′. Only line 32L′ and 32F′ are part of a closed contour as lines 32C/32C′ and 32D/32D′ have been traversed twice. As there are 4 lines connected to node 31g′, therefore the line 32F′ that makes the smallest angle with line 32L′ is traversed, to arrive at node 31e′.

Here the print head moves down again to layer 1 to traverse from node 31e to node 31d over line 32E, which is the only available line on layer 1.

The print head then moves up to node 31d′, and traverse from node 31d′ to node 31h′ over line 32J′. This is because available lines at node 31′ on layer 2 are 32E′, 32L′ and 32J′. Only line 32E and 32J are part of a closed contour as lines 32C/32C′, 32D/32D′ and 32F/32F′ have been traversed twice. There are 4 lines connected to node 31d′, therefore the line 32J′ that makes the smallest angle from line 32E is traversed. Then from node 31h′ to node 31e′ over the only available line 32N, and from node 31e′ back to node 31d′ over the only available line 32E′.

Thereafter, the print head traverses from node 31d′ to node 31g′ over the only available line 32L′, from node 31g′ to node 31a′ over the only available line 32K′, and traverses from node 31a′ to node 31b′ over the only available line 32A′.

The print head in the end traverses from node 31b′ to node 33′ over the only available line 32B′. All lines on both layer 1 and layer 2 have now been traversed the same, even amount of times and the print head is now right above the starting position.

In addition to the above general principle for designing the toolpath following the method of the present disclosure, there are some additional design considerations respectively for the first layer and the second layer.

As an example, on the first layer, the print head will trace a branch which is not comprised in any closed contour when such a branch is available to be traced at a node which the print head is now at.

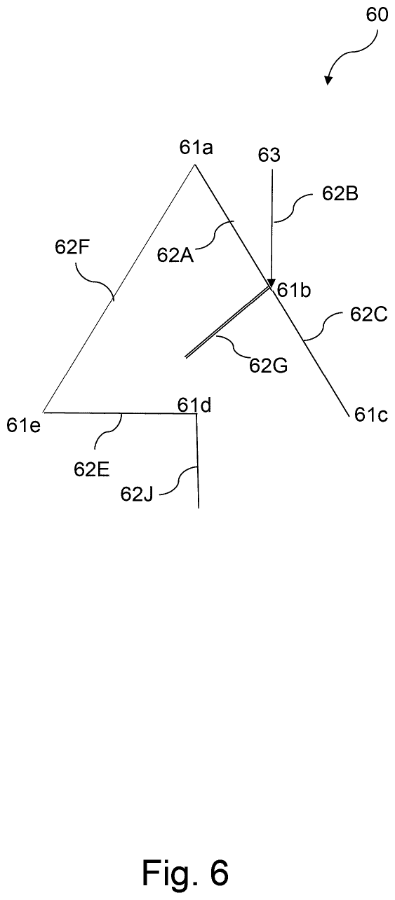

In case the print head arrives at a node with several branches, the print head moves forward following the following example as illustrated in FIG. 6.

In FIG. 6, a layer indicated with reference number 60 is shown. It is assumed that the print head arrives at node 61b from point 63 by following a line 62B. It is further assumed that node 61b is connected to three lines 62A, 62B and 62C, that is, node 61b is connected three lines or less. In this case, it is preferred that the print head will follow a line forming the largest angle with the line that is just traced. In the example of FIG. 6, line 62C forms a larger angle with line 62B than line 62A, therefore, the print head will move along line 62C next.

If it is assumed that there is a further line 62G, illustrated as a double line in FIG. 6, connected to node 61b, the print head after arriving at node 61b, will follow a line 62A that makes the smallest angle with the line 62B that is just traced.

In short, in the case of arriving at a node connected to a branch, if there are four or more lines connected to the node, the print head will follow a line forming the smallest angle with the line that is just traced. Otherwise, the print head follows a line that forms the largest angle with the line that is just traced.

In contrast, when the print head arrives at a node not connected to a branch, it will follow a line forming the smallest angle with the line that is just traced when there are four or more lines connected to the node. In case there are three or two lines connected to the node that the print head is currently at, the print head follows a line that forms the largest angle with the line that is just traced.

Another strategy that the present disclosure follows in calculating the toolpath relates to calculating the toolpath for the second layer.

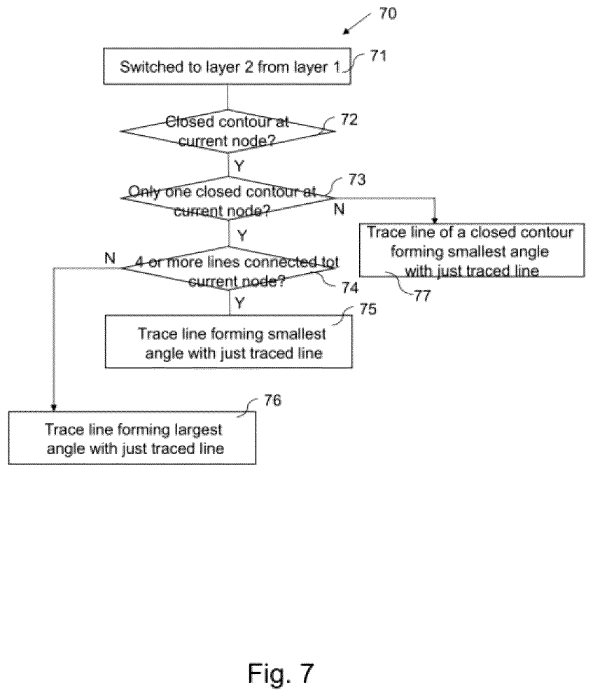

FIG. 7 schematically illustrates, in a flow chart type diagram, an exemplary method 70 for calculating the toolpath on the second layer.

After the print head moves from the first layer to the second layer to a current node at step 71, it is checked if there is one or more closed contour connected to the current node at step 72.

If there is indeed one or more closed contours connected to the current node on the second layer, the print head will first follow a closed contour instead of following a branch that may also be connected to the node. At step 73, it is decided whether there is more than one closed contour connected to the current node. If there is only one closed contour connected to the current node (step 73 has a Y decision), theoretically the print head will trace the closed contour to get back to the current node again. Therefore, the print head can go either direction from the current node to trace the closed contour.

In practice, when there is only one closed contour at the current node, if there are four or more lines connected to the current node (step 74 has a Y decision), including two lines which are part of the closed contour, it is preferred that the print head will trace a line of the closed contour which forms the smallest angle with the line just traced, as in step 75. Otherwise, it is preferred that the print head will trace a line of the closed contour which forms the largest angle with the line just traced, as shown in step 76.

In it is decided at step 73 that there is more than one closed contour connected to the current node, at step 77, the print head will follow a line of a closed contour that makes the smallest angle with the line that the print head just traced.

If it decided at step 72 that no closed contour is connected to the current node, it basically means there are only branches available on the second layer. This is the same scenario as described above with reference to calculating the toolpath when arriving at a branch. The movement of the print head in this case will be the same as described above. That is, if there are four or more lines connected to the node, the print head will follow a line forming the smallest angle with the line that is just traced. Otherwise, the print head follows a line that forms the largest angle with the line that is just traced.

It is noted that above strategy may also be followed for nodes on layer 1. The difference lies in that on layer 2 it has to decide to come back to layer one as soon as possible. Therefore, for the flow chart 70 of FIG. 7, after finishing each of steps 75, 76 and 77, if it is possible to switch back to layer one, the print head will go back to layer 1. Otherwise, further lines may be traced following the same decision strategy.

In considering the closed contour, when corresponding lines on both layers are traced, the lines will not be considered any more as a part of a closed contour.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method for calculating a toolpath for a three-dimensional, 3D, model for additive manufacturing, the method performed by a processor and comprising the steps of:
slicing the 3D model into a first even number of layers, each layer comprising a plurality of lines and a plurality of nodes having one or more lines connected thereto;
calculating the toolpath per second even number of layers such that movement of a print head on each one of the second even number of layers always traces a line without any interruption, by switching to another one of the second even number of layers for a particular node, the particular node being a node on one of the second even number of layers where movement of the print head from the node to another node, on the same layer, without tracing a line is needed,
wherein the second even number being smaller or equal to the first even number.

2. The method according to claim 1, wherein the particular node on one of the second even number of layers comprises a node having all lines connected thereto on the same layer traced once.

3. The method according to claim 1, wherein the second even number of layers comprises two layers, the calculating step comprises:
tracing lines on a first layer by repeatedly moving the print head from a current node to a further node by tracing a line connecting the current node and the further node until reaching a particular node on the first layer
determining that there are untraced lines on the first layer;
switching to a second layer by moving the print head in a direction across the two layers to reach a corresponding particular node on the second layer;
tracing one or more lines on the second layer starting from the corresponding particular node until reaching a node on the second layer where tracing a line from a corresponding node on the first layer becomes possible;
switching back to the first layer by moving the print head in a direction across the two layers to reach the corresponding node on the first layer as a current node;
repeating the above steps until all lines on the first layer are traced once.

4. The method according to claim 3, further comprising the steps of:
switching to the second layer by moving the print head in a direction across the two layers to reach a node on the second layer, when all lines on the first layer are traced once;
tracing lines on the second layer by repeatedly moving the print head from a current node to a further node by tracing a line connecting the current node and the further node until all lines on the second layer are traced once.

5. The method according to claim 3, where the step of tracing lines on the first layer starts with a starting node selected by the steps of:
finding nodes that are closest to each other across all of the first even number of layers;
selecting one of the found nodes on the first layer as the starting node.

6. The method according to claim 3, wherein the steps of tracing comprises:
tracing a line connected to a current node where the print head is and making the smallest angle with an immediately traced line, when four or more lines are connected to the current node.

7. The method according to claim 6, wherein the line connected to a current node where the print head is and making the smallest angle with the immediately traced line comprises a line belonging to a closed contour connected to the current node and a branch not belonging to a closed contour connected to the current node.

8. The method according to claim 3, wherein the tracing steps comprises:
tracing a line connected to a current node where the print head is and making the largest angle with an immediately traced line, when three or fewer lines are connected to the current node.

9. The method according to claim 8, wherein the line connected to a current node where the print head is and making the largest angle with an immediately traced line comprises a line belonging to a closed contour connected to the current node and a branch not belonging to a closed contour connected to the current node.

10. The method according to claim 3, wherein the step of tracing lines on the first layer comprises tracing a branch when both branches and closed contoured are connected to a current node where the print head is.

11. The method according to claim 3, wherein the step of tracing one or more lines on the second layer comprises first tracing a line belonging to an available closed contour(s) connected to the corresponding particular node on the second layer before tracing a branch not belonging to any closed contour.

12. The method according to claim 11, wherein tracing a line belonging to an available closed contour(s) connected to the corresponding particular node comprises:
tracing a line of a closed contour among two or more closed contours connected to the corresponding particular node and forming the smallest angle with the immediately traced line.

13. The method according to claim 11, wherein tracing a line belonging to an available closed contour(s) connected to the corresponding particular node comprises:
tracing a line of a single closed contour connected to the corresponding particular node and forming the smallest angle with the immediately traced line, when four or more lines are connected to the corresponding particular node, or
tracing a line of a single closed contour connected to the corresponding particular node and forming the largest angle with the immediately traced line, when three or fewer lines are connected to the corresponding particular node.

14. The method according to claim 3, wherein the step of tracing one or more lines on the second layer comprises:
tracing a branch not belonging to a closed contour and connected to the corresponding particular node and making the smallest angle with an immediately traced line, when four or more lines are connected to the corresponding particular node, or
tracing a branch not belonging to a closed contour and connected to the corresponding particular node and making the largest angle with an immediately traced line, when three or fewer lines are connected to the corresponding particular node.

15. The method according to claim 1, wherein the method is performed by a processing device.

16. A non-transitory computer readable medium storing instructions for calculating a toolpath for a three-dimensional, 3D, model for additive manufacturing, the instructions executed by a processor to perform the steps of:
slicing the 3D model into a first even number of layers, each layer comprising a plurality of lines and a plurality of nodes having one or more lines connected thereto;
calculating the toolpath per second even number of layers such that movement of a print head on each one of the second even number of layers always traces a line without any interruption, by switching to another one of the second even number of layers for a particular node, the particular node being a node on one of the second even number of layers where movement of the print head from the node to another node, on the same layer, without tracing a line is needed,
wherein the second even number being smaller or equal to the first even number.
